(19) United States
(12) Patent Application Publication
(10) Pub. No.: US 2013/0050444 A1
(43) Pub. Date: Feb. 28, 2013

(54) VIDEO PROCESSING APPARATUS AND VIDEO PROCESSING METHOD

(71) Applicant: Takahiro Takimoto, Sayama-Shi (JP)

(72) Inventor: Takahiro Takimoto, Sayama-Shi (JP)

(73) Assignee: KABUSHIKI KAISHA TOSHIBA, Tokyo (JP)

(21) Appl. No.: 13/406,020

(22) Filed: Feb. 27, 2012

(30) Foreign Application Priority Data
Aug. 31, 2011 (JP) 2011-189478

(51) Int. Cl. H04N 13/04

(52) U.S. Cl. 348/51; 348/E13.075

(57) ABSTRACT

According to an embodiment, a video processing apparatus includes a display, an aperture control unit, an observation unit, a viewer detector, a presentation unit, a viewer selection unit, a calculator and a controller. The display is configured to display a plurality of parallax images. The observation unit is configured to obtain an observation image including one or more viewers. The viewer detector is configured to detect positions of the one or more viewers. The viewer selection unit is configured to select one or more viewers in the observation image according to a viewer selection signal. The calculator is configured to calculate a control parameter so that a viewing zone, from which the plurality of parallax images can be seen stereoscopically, is set in areas according to positions of the selected one or more viewers. The controller is configured to control the viewing zone according to the control parameter.

### CROSS REFERENCE TO RELATED APPLICATION

This application is based upon and claims the benefit of priority from the prior Japanese Patent Application No. 2011-189478 filed on Aug. 31, 2011 in Japan, the entire contents of which are incorporated herein by reference.

### FIELD

Embodiments described herein relate generally to a video processing apparatus and a video processing method.

### BACKGROUND

In recent years, a stereoscopic video display apparatus (so-called autostereoscopic television) has been widely used. A viewer can see the video displayed on the autostereoscopic television stereoscopically without using special glasses. This stereoscopic video display apparatus displays a plurality of images with different viewpoints. Then, the output directions of light rays of those images are controlled by, for example, a parallax barrier, a lenticular lens or the like, and guided to both eyes of the viewer. When a viewer's position is appropriate, the viewer sees different parallax images respectively with the right and left eyes, thereby recognizing the video as stereoscopic video. An area from which the viewer can see a stereoscopic video in this way is referred to as “viewing zone”.

However, there is a problem that such a viewing zone is limited. Specifically, for example, there is a reverse view region that is an observation position in which the viewpoint of an image seen by the left eye is located right of the viewpoint of an image seen by the right eye and from which the stereoscopic video cannot be recognized correctly. Therefore, in an autostereoscopic video display apparatus, it is difficult for a viewer to observe a good stereoscopic video depending on the viewing position.

### BRIEF DESCRIPTION OF THE DRAWINGS

FIG. 1 is an external view of a video processing apparatus according to an embodiment.

FIG. 2 is a block diagram showing a schematic configuration of the video processing apparatus.

FIGS. 3A to 3C are views of part of each of a liquid crystal panel and a lenticular lens seen from above.

FIG. 4 is a diagram showing an observation image and an overhead view image displayed on a part of the liquid crystal panel.

FIGS. 5A to 5E are views showing an example of a method for calculating a control parameter.

FIG. 6 is a flowchart showing a viewing zone adjustment method according to an embodiment.

FIGS. 7A and 7B are diagrams for explaining priority allocation to viewers by a priority allocation rule according to an embodiment.

FIG. 8 is a block diagram showing a schematic configuration of a video processing apparatus according to a modified example.

### DETAILED DESCRIPTION

According to an embodiment, a video processing apparatus includes a display, an aperture control unit, an observation unit, a viewer detector, a presentation unit, a viewer selection unit, a calculator and a controller. The display is configured to display a plurality of parallax images. The aperture control unit is configured to output the plurality of parallax images displayed on the display unit in a direction. The observation unit is configured to obtain an observation image including one or more viewers are observed. The viewer detector is configured to detect positions of the one or more viewers in the observation image. The presentation unit is configured to present the observation image to the one or more viewers. The viewer selection unit is configured to select one or more viewers in the observation image according to a viewer selection signal. The calculator is configured to calculate a control parameter so that a viewing zone, from which the plurality of parallax images can be seen stereoscopically, is set in areas according to positions of the selected one or more viewers. The controller is configured to control the viewing zone according to the control parameter.

Hereinafter, embodiments of the present invention will be described with reference to the drawings. These embodiments do not limit the present invention.

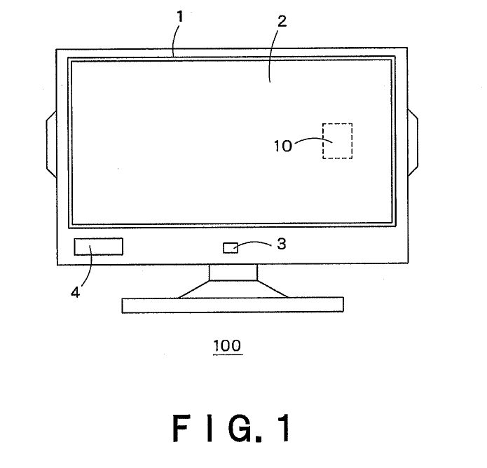

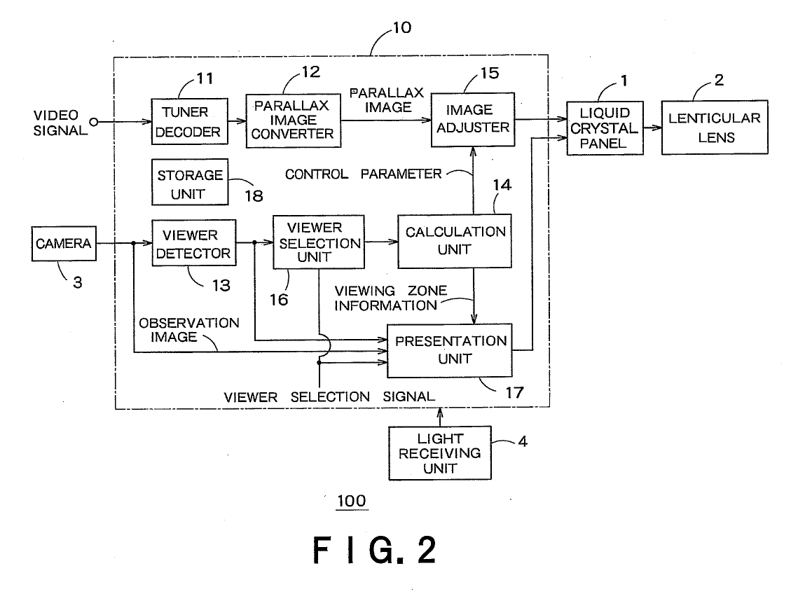

FIG. 1 is an external view of a video processing apparatus 100 according to an embodiment. FIG. 2 is a block diagram showing a schematic configuration of the video processing apparatus 100. The video processing apparatus 100 includes a liquid crystal panel 1, a lenticular lens 2, a camera 3, a light receiving unit 4, and a controller 10.

The liquid crystal panel (display unit) 1 is, for example, a panel of 55 inch size, in which 11520 (=1280*9) pixels are arranged in the horizontal direction and 720 pixels are arranged in the vertical direction. In each pixel, three sub-pixels, which are R sub-pixel, G sub-pixel, and B sub-pixel, are formed in the vertical direction. The liquid crystal panel 1 is irradiated with light from a backlight device (not shown in FIG. 1) provided on the back surface thereof. Each pixel lets light, which has a luminance according to a parallax image signal (described later) supplied from the controller 10, pass through. That is, the liquid crystal panel 1 displays a plurality of parallax images.

The lenticular lens (aperture control unit) 2 has a plurality of convex portions arranged along the horizontal direction of the liquid crystal panel 1. The number of the convex potions is 1/9 of the number of the pixels in the horizontal direction in the liquid crystal panel 1. The lenticular lens 2 is attached to the surface of the liquid crystal panel 1 so that each convex portion corresponds to nine pixels arranged in the horizontal direction. The light having passed through each pixel is output from the vicinity of the top of the convex portion in a particular direction with directivity. That is, the lenticular lens 2 outputs a plurality of parallax images displayed on the liquid crystal panel 1 in a predetermined direction.

The liquid crystal panel 1 of the present embodiment is capable of displaying stereoscopic video by a multi-parallax system (integral imaging system) with not less than three parallaxes or a two-parallax system, and other than those, it is also capable of displaying normal two-dimensional video.

In the description below, an example will be described in which nine pixels are provided for each convex portion of the liquid crystal panel 1 and a multi-parallax system of nine parallaxes can be employed. In the multi-parallax system, first to ninth parallax images are respectively displayed in the nine pixels corresponding to each convex portion. The first to ninth parallax images are images in which an object is viewed respectively from nine viewpoints arrayed along the horizontal direction of the liquid crystal panel 1. The viewer can respectively view one parallax image among the first to ninth parallax images with the left eye and another one parallax image with the right eye via the lenticular lens 2, so as to stereoscopically view the video. According to the multi-parallax system, as the number of the parallax is increased, the viewing zone can be wider. The viewing zone is an area in which a video can be stereoscopically viewed when the liquid crystal panel 1 is seen from the front of the liquid crystal panel 1.

On the other hand, in the two-parallax system, parallax images for a right eye are displayed in four pixels and parallax images for a left eye are displayed in the other five pixels among the nine pixels corresponding to each convex portion. The parallax images for a left eye and a right eye are images obtained by viewing the object from a left-side viewpoint and a right-side viewpoint respectively among the two viewpoints arrayed in the horizontal direction. The viewer can view the parallax image for a left eye with the left eye and the parallax image for a right eye with the right eye via the lenticular lens 2, so as to stereoscopically view the video. According to the two-parallax system, a three-dimensional appearance of displayed video is easier to obtain than in the multi-parallax system, but a viewing zone is narrower than that in the multi-parallax system.

The liquid crystal panel 1 can also display a two-dimensional image by displaying the same image on the nine pixels corresponding to each convex portion.

In the embodiment, the viewing zone can be variably controlled according to a relative positional relationship between the convex portions of the lenticular lens 2 and the displayed parallax images, that is, according to how the parallax images are displayed on the nine pixels corresponding to each convex portion. Hereinafter, the control of the viewing zone will be described using the multi-parallax system as an example.

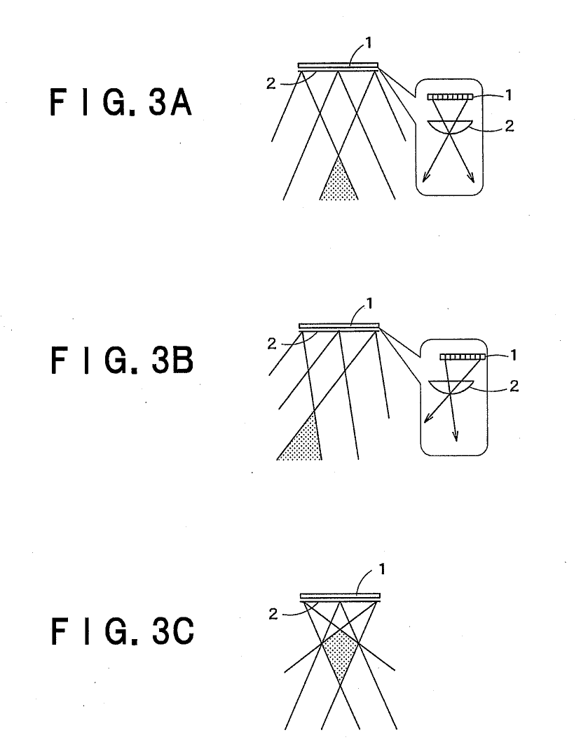

FIG. 3 is a view of part of each of the liquid crystal panel 1 and the lenticular lens 2 seen from above. The shaded areas in FIG. 3 indicate the viewing zones. When seeing the liquid crystal panel 1 from the viewing zones, stereoscopic video can be seen. The other areas are areas where a reverse view or a crosstalk is generated, and it is difficult to view the video stereoscopically therefrom.

FIG. 3 shows a state where the viewing zone changes depending on a relative positional relation between the liquid crystal panel 1 and the lenticular lens 2, more specifically, a distance between the liquid crystal panel 1 and the lenticular lens 2 or a horizontal shift amount between the liquid crystal panel 1 and the lenticular lens 2.

In practice, the lenticular lens 2 is positioned with respect to the liquid crystal panel 1 with a high degree of accuracy and attached to the liquid crystal panel 1, so that it is difficult to physically change the relative positions of the liquid crystal panel 1 and the lenticular lens 2.

Accordingly, in the present embodiment, display positions of the first to ninth parallax images displayed in the respective pixels of the liquid crystal panel 1 are shifted, to apparently change the relative positional relation between the liquid crystal panel 1 and the lenticular lens 2 so as to adjust the viewing zone.

For example, as compared with the case of the first to ninth parallax images being respectively displayed in the nine pixels corresponding to each convex portion (FIG. 3A), the viewing zone moves to the left side when the parallax images are shifted to the right side and displayed (FIG. 3B). On the other hand, the viewing zone moves to the right side when the parallax images are shifted to the left side and displayed.

Further, the viewing zone goes to approach to the liquid crystal panel 1 when the parallax image is not shifted near the center in the horizontal direction and the parallax image is shifted outward to a larger degree on the more external side of the liquid crystal panel 1 (FIG. 3C). A pixel between a shifted pixel and a pixel that is not shifted and a pixel between pixels that are shifted by different amounts may be appropriately interpolated according to surrounding pixels. Further, as opposed to FIG. 3C, the viewing zone moves in a direction away from the liquid crystal panel 1 when the parallax image is not shifted near the center in the horizontal direction and the parallax image is shifted to the center side to a larger degree on the more external side of the liquid crystal panel 1.

In this way, when all or part of the parallax images are shifted and displayed, the viewing zone can be moved in the left-right direction or the front-back direction with respect to the liquid crystal panel 1. Although, in FIG. 3, only one viewing zone is shown in order to simplify the description, actually, there are a plurality of viewing zones and the viewing zones moves in conjunction with each other. The viewing zones are controlled by the controller 10 in FIG. 2 described later.

Return to FIG. 1, the camera (observation unit) 3 is attached to a lower center portion of the liquid crystal panel 1 at a predetermined elevation angle, and the camera 3 captures an image in a predetermined range in front of the liquid crystal panel 1. That is, the camera 3 obtains an observation image (camera image) in which one or a plurality of viewers are observed. However, the position to which the camera is attached is not limited to the position described above. The observation image is supplied to the controller 10 and used to detect information related a viewer such as the position of the viewer and the face of the viewer. The observation image is supplied to the liquid crystal panel 1 via the controller 10. Thereby the observation image is presented to the viewer and used to select the viewer for which the viewing zone is adjusted. The camera 3 may capture a moving image or a still image. The camera 3 may be a monocular camera, stereo camera, a multiple camera, a visual camera, an infrared camera, or the like. The observation image may be obtained by using a sensor, a radar, or the like as an observation unit instead of the camera 3. However, when a sensor, a radar, or the like is used, the observation image cannot be obtained directly, so that it is preferable to generate the observation image by using CG (computer graphics), animation, or the like.

The light receiving unit (operation signal receiving unit) 4 is provided, for example, in lower left portion of the liquid crystal panel 1. The light receiving unit 4 receives an infrared signal transmitted from a remote controller used by the viewer. The infrared signal includes a signal indicating whether a stereoscopic video or a two-dimensional video is displayed, whether the multi-parallax system or the two-parallax system is used when the stereoscopic video is displayed, whether the viewing zone is controlled or not, and the like. The infrared signal includes a viewer selection signal for selecting a viewer for which the viewing zone is adjusted.

As shown in FIG. 2, the controller 10 includes a tuner decoder 11, a parallax image converter 12, a viewer detector 13, a calculation unit 14, an image adjuster 15, a viewer selection unit 16, a presentation unit 17, and a storage unit 18. The controller 10 is implemented as one IC (integrated circuit) and disposed on the back side of the liquid crystal panel 1. Of course, a part of the controller 10 may be implemented as software.

The tuner decoder (receiving unit) 11 receives an input broadcast wave, selects a channel, and decodes a coded video signal. When a data broadcast signal such as an electronic program guide (EPG) is superimposed on the broadcast wave, the tuner decoder 11 extracts the data broadcast signal. Or, the tuner decoder 11 receives a coded video signal instead of a broadcast wave from a video output device such as an optical disc reproduction device and a personal computer and decodes the coded video signal. The decoded signal is also called a baseband video signal and supplied to the parallax image converter 12. If the video processing apparatus 100 does not receive a broadcast wave and exclusively displays a video signal received from the video output device, the video processing apparatus 100 may include a decoder simply having a decoding function instead of the tuner decoder 11 as a receiving unit.

The video signal received by the tuner decoder 11 may be a two-dimensional video signal or may be a three-dimensional video signal including images for a left eye and a right eye in a frame packing (FP) format, a side-by-side (SBS) format, a top-and-bottom (TAB) format, or the like. Further, the video signal may be a three-dimensional video signal including images of equal to or more than three parallaxes.

In order to display stereoscopic video, the parallax image converter 12 converts a baseband video signal to a plurality of parallax image signals and provide them to the image adjuster 15. A processing of the parallax image converter 12 varies depending on which system, the multi-parallax system or the two-parallax system, is adopted. Further, the processing of the parallax image converter 12 also varies depending on whether the baseband video signal is a two-dimensional video signal or a three-dimensional video signal.

In the case of adopting the two-parallax system, the parallax image converter 12 generates parallax image signals for a left eye and a right eye corresponding to parallax images for a left eye and a right eye, respectively. More specifically, the following will be performed.

When the two-parallax system is adopted and a three-dimensional video signal including images for a left eye and a right eye is input, the parallax image converter 12 generates parallax image signals for a left eye and a right eye in a format which can be displayed on the liquid crystal panel 1. Further, when a three-dimensional video signal including equal to or more than three images is input, the parallax image converter 12, for example, uses arbitrary two images among them to generate parallax image signals for a left eye and a right eye.

As opposed to this, in a case where the two-parallax system is adopted and a two-dimensional video signal including no parallax information is input, the parallax image converter 12 generates parallax images for a left eye and a right eye based on a depth value of each pixel in the video signal. The depth value is a value indicating that to what extent each pixel is displayed so as to be viewed in front of or in the back of the liquid crystal panel 1. The depth value may be previously added to a video signal, or may be generated by performing motion detection, identification of a composition, detection of a human's face, or the like. In the parallax image for a left eye, a pixel viewed in front needs to be shifted to the right side of a pixel viewed in the back, and to be displayed. For this reason, the parallax image converter 12 performs processing of shifting the pixel viewed in front to the right side in the video signal, to generate a parallax image signal for a left eye. The larger the depth value is, the larger the shift amount is.

Meanwhile, in the case of adopting the multi-parallax system, the parallax image converter 12 generates first to ninth parallax image signals corresponding to first to ninth parallax images, respectively. More specifically, the following will be performed.

When the multi-parallax system is adopted and a two-dimensional video signal or a three-dimensional video signal including less than nine parallaxes is input, the parallax image converter 12 generates first to ninth parallax image signals based on depth information similar to generating parallax image signals for a left eye and a right eye from a two-dimensional video signal.

When the multi-parallax system is adopted and a three-dimensional video signal including nine parallaxes is input, the parallax image converter 12 generates first to ninth parallax image signals using the video signal.

The viewer detector 13 detects positions and faces of one or a plurality of viewers by using an observation image observed by the camera 3 and supplies position information and face information of the viewers (viewer recognition information) to the viewer selection unit 16 and the presentation unit 17. The viewer detector 13 can follow a viewer based on the face information of the viewer even when the viewer moves. Therefore, as described later, it is possible to cause the viewing zone to follow a selected viewer (auto-tracking mode) and know a viewing time for each viewer.

The position information of a viewer is represented as a position on the X axis (horizontal direction), the Y axis (vertical direction), and the Z axis (direction perpendicular to the liquid crystal panel 1) using the center of the liquid crystal panel as the origin, for example. More specifically, the viewer detector 13, first, recognizes a viewer by detecting a face from the observation image. Next, the viewer detector 13 calculates a position on the X axis and the Y axis from the position of the face in the observation image and calculates a position on the Z axis from the size of the face. When there are a plurality of viewers, the viewer detector 13 may detect positions of a predetermined number of viewers, for example, positions of 10 viewers. In this case, if the number of detected faces is greater than 10, for example, positions of 10 viewers are detected in ascending order of the distance between the viewer and the liquid crystal panel 1, that is, in ascending order of the position on the Z axis.

The presentation unit 17 supplies the observation image observed by the camera 3 to the liquid crystal panel 1 to present the image to the viewers. At this time, the presentation unit 17 can add a frame to faces of the viewers whose positions on the observation image are detected based on the position information of the viewers from the viewer detector 13. A viewer can know whether or not the viewer is recognized from the presence or absence of the frame.

Further, the presentation unit 17 generates an overhead view image that shows a positional relationship among the liquid crystal panel 1, the viewing zones, and the viewers by using the position information of the viewers and the viewing zone information that shows a pattern of the viewing zones currently set from the calculation unit 14. The presentation unit 17 supplies the generated overhead view image to the liquid crystal panel 1 to present the image to the viewers. That is, the overhead view image shows a state in which the liquid crystal panel 1 and watching zones are looked down from above. The watching zones are zones from which the viewers can observe the 3D image displayed on the liquid crystal panel 1. A viewer can know whether or not the viewer is in a viewing zone by seeing the overhead view image.

The presentation unit 17 supplies at least one of the observation image and the overhead view image to the liquid crystal panel 1. Thereby, the liquid crystal panel 1 can display at least one of the observation image and the overhead view image. The observation image and the overhead view image are displayed as two-dimensional images. However, the overhead view image may be displayed as a stereoscopic video (three-dimensional image like computer graphics).

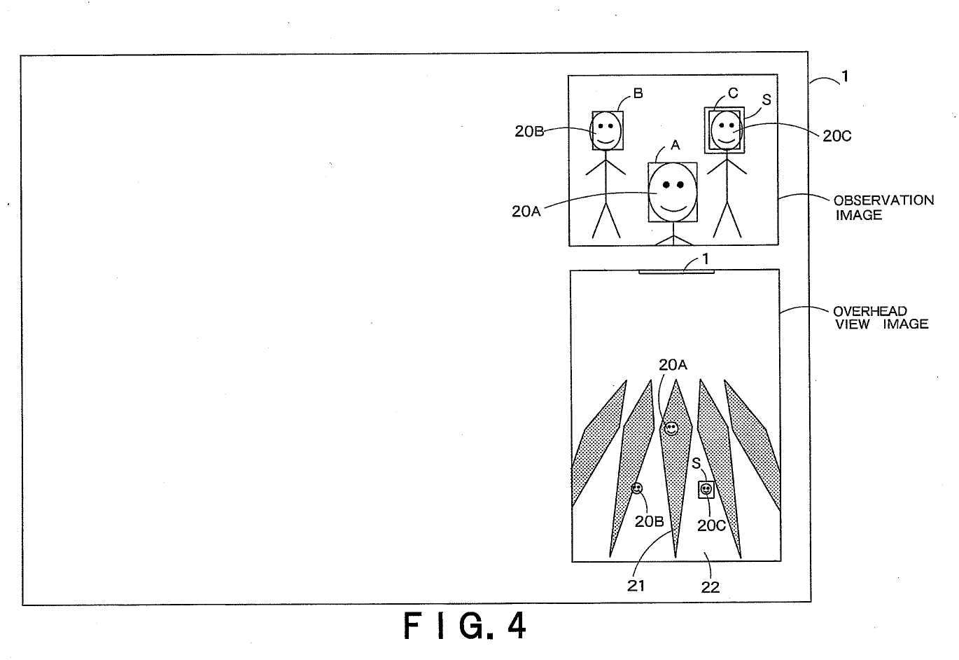

FIG. 4 shows the observation image and the overhead view image displayed on a part of the liquid crystal panel 1. As an example, the observation image and the overhead view image arranged vertically are displayed on the right side of the liquid crystal panel 1. Frames A, B, and C are respectively added to faces of viewers 20A, 20B, and 20C on the observation image. A selection frame S is added to the face of the viewer 20C on the observation image and the overhead view image. In the example shown in FIG. 4, as known from the overhead view image, the viewer 20A is in the viewing zone 21, so that the viewer 20A can observe a stereoscopic video. Although a part of the viewer 20B is in the viewing zone 21, the viewer 20B may not be able to observe the stereoscopic video. The viewer 20C is in a reverse view region 22, so that the viewer 20C cannot observe the stereoscopic video.

The observation image and the overhead view image may be arranged horizontally or obliquely, or may be displayed on the entire screen of the liquid crystal panel 1. The observation image and the overhead view image may be superimposed on other images such as an image of a broadcast wave, or may not be superimposed on other images.

The viewer selection unit 16 selects one or more viewers from one or a plurality of viewers on the observation image or the overhead view image according to an input viewer selection signal. For example, the viewer selection signal is a signal transmitted when a cursor button or a decision button on the remote controller is pressed. Specifically, the viewer selection unit 16 selects position information of one or more viewers from the position information of one or a plurality of viewers supplied from the viewer detector 13, and supplies the selected position information of the viewers to the calculation unit 14.

At this time, for example, as shown in FIG. 4, the presentation unit 17 can change a viewer to which the selection frame S is added according to the viewer selection signal by adding the selection frame S to a certain viewer on the observation image or the overhead view image. Thereby, a viewer can select the viewer by, for example, pressing the cursor button on the remote controller to move the selection frame S and pressing the decision button while the selection frame S is added to the desired viewer.

The viewer selection signal may also be input from a signal input unit (not shown in the drawings) such as a touch panel displayed on the liquid crystal panel 1.

The viewer selection unit 16 may select one or more viewers by giving a priority to each viewer according to the viewer selection signal. In this case, for example, the viewer who is selected earlier may get the higher priority. Or, when selecting viewers, the viewer may input the priorities by using a remote controller.

The viewer selection unit 16 may give a priority to a selected viewer according to a predetermined priority allocation rule. The priority allocation rule will be described later. A plurality of priority allocation rules are set in advance. A viewer may select a desired priority allocation rule from the plurality of priority allocation rules by using a menu screen or the like, or a predetermined priority allocation rule may be set at the time of shipment of the product.

The calculation unit 14 calculates a control parameter so that viewing zones are appropriately set in areas according to the positions of the viewers selected by the viewer selection unit 16 and supplies the control parameter to the image adjuster 15. The control parameter indicates, for example, an amount of shifting the parallax images described in FIG. 3.

More specifically, to set desired viewing zones, the calculation unit 14 uses a viewing zone database in which control parameters are respectively associated with viewing zones set by the control parameters. The viewing zone database is stored in the storage unit 18 in advance. The calculation unit 14 detects viewing zones which can accommodate selected viewers by searching the viewing zone database. The calculation unit 14 supplies viewing zone information indicating viewing zones determined to be appropriate to the presentation unit 17.

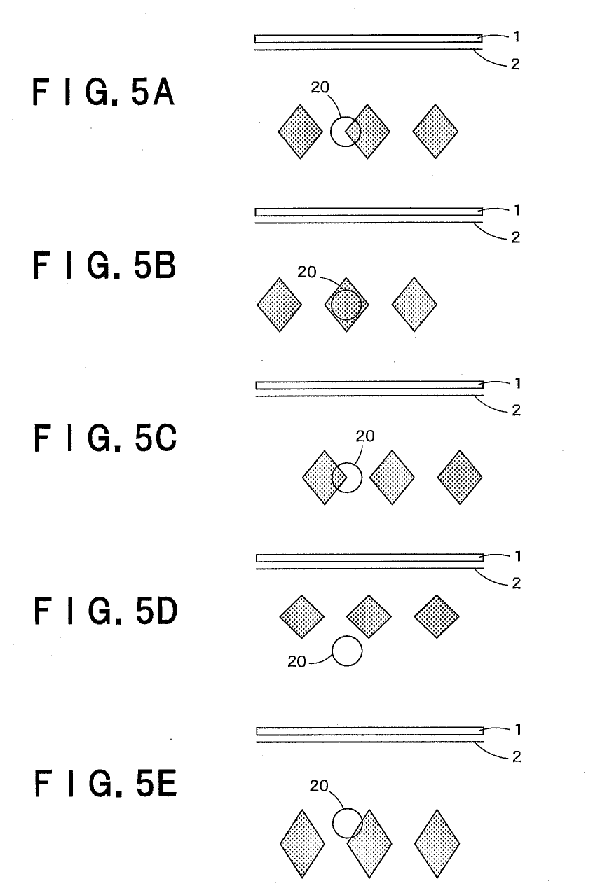

FIG. 5 is a view showing an example of a method for calculating the control parameter. A case in which one viewer is selected by the viewer selection unit 16 will be described. The calculation unit 14 calculates an area in which a viewing zone and the selected viewer overlap each other for each viewing zone stored in the viewing zone database, and determines that a viewing zone that includes a maximum overlapping area is an appropriate viewing zone. In the example of FIG. 5, among the predetermined five patterns of viewing zones (shaded areas) shown in FIGS. 5A to 5E, the area in which a viewing zone and a viewer 20 overlap each other is maximum in FIG. 5B in which the viewing zones are set leftward with respect to the liquid crystal panel 1. Therefore, the calculation unit 14 determines that the pattern of the viewing zones of FIG. 5B is the appropriate viewing zones. In this case, a control parameter for displaying the parallax images in the pattern of the viewing zones of FIG. 5B is supplied to the image adjuster 15 of FIG. 2.

When a plurality of viewers are selected by the viewer selection unit 16, the calculation unit 14 first calculates the control parameter so that viewing zones are set in areas according to the positions of all the selected viewers. In other words, the calculation unit 14 calculates the control parameter so that all the selected viewers can equally observe a stereoscopic video.

However, the viewing zones may not be able to be set equally depending on the number of the selected viewers and the positions of the viewers. Therefore, if the calculation unit 14 cannot calculate the control parameter so that the viewing zones are set in areas according to the positions of all the selected viewers, the calculation unit 14 calculates the control parameter so that a viewing zone is set in an area according to a position of a selected viewer to which the highest priority is given.

For example, in the example of FIG. 4, when the three viewers 20A, 20B, and 20C are selected, the viewing zones 21 cannot be set in areas according to the positions of all the selected viewers 20A, 20B, and 20C. Specifically, if the viewing zones 21 are moved leftward from the example of the overhead view image in FIG. 4 to the liquid crystal panel 1 so that the viewer 20C enters a viewing zone 21, the viewer 20B is out of the viewing zones 21. Similarly, if the viewing zones 21 are moved rightward from the example in FIG. 4 to the liquid crystal panel 1 so that the entire viewer 20B enters a viewing zone 21, the viewer 20C is out of the viewing zones 21. Therefore, in this example, if the priority of the viewer 20A is the highest, the viewing zones are set so that the viewer 20A enters a viewing zone 21.

When the calculation unit 14 cannot calculate the control parameter as described above, the calculation unit 14 may calculate a control parameter for setting viewing zones that accommodate viewers with relatively high priorities among the selected viewers and do not accommodate viewers with relatively low priorities. For example, first, the calculation unit 14 excludes the viewer with the lowest priority among the selected viewers and tries to calculate a control parameter for setting viewing zones so that the viewing zones accommodate all the remaining viewers. Nevertheless, if the calculation unit 14 still cannot calculate the control parameter, the calculation unit 14 excludes the viewer with the lowest priority among the remaining viewers and tries to calculate the control parameter. By repeating the above process, it is possible to accommodate viewers with relatively high priorities in the viewing zones at all times.

Alternately, it is allowed that the calculation unit 14 does not calculate the control parameter so that the viewing zones are set in areas according to the positions of all the selected viewers and, from the beginning, the calculation unit 14 calculates the control parameter so that the viewing zone is set in an area according to the position of a selected viewer to which the highest priority is given.

The image adjuster (viewing zone control unit) 15 adjusts the parallax image signal so that the parallax image signal is shifted and interpolated according to the calculated control parameter in order to control the viewing zones, and then supplies the parallax image signal to the liquid crystal panel 1. Thereby, the liquid crystal panel 1 displays a plurality of parallax images according to the adjusted parallax image signal.

The storage unit 18 is a non-volatile memory such as a flash memory and stores the priority allocation rule, user registration information described later, 3D priority viewer information, and initial viewing position in addition to the viewing zone database. The storage unit 18 may be provided outside the controller 10.

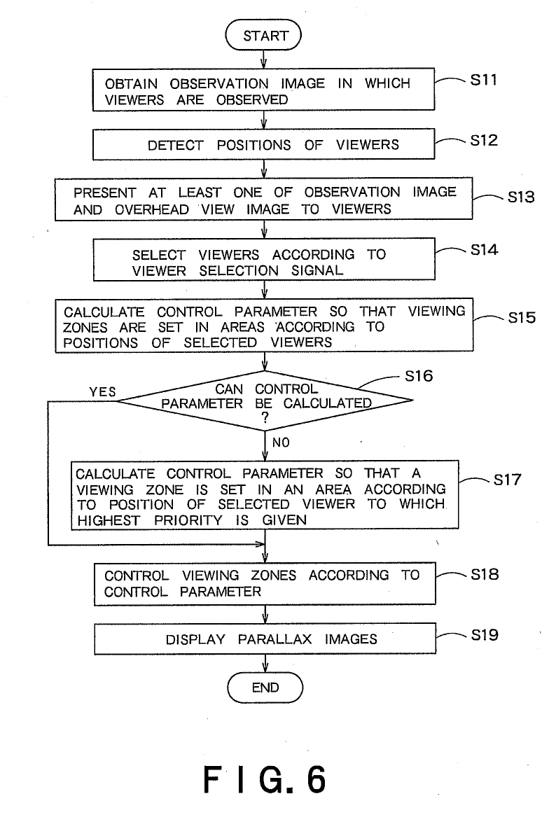

In the video processing apparatus 100 of the embodiment, for example, it is possible to adjust the viewing zones by using, for example, a three-dimensional viewing position check function. Hereinafter, the method for adjusting the viewing zones by using the three-dimensional viewing position check function will be described with reference to FIG. 6. The three-dimensional viewing position check function can be started by, for example, pressing a predetermined button on the remote controller. The three-dimensional viewing position check function can adjust the viewing zones in a state in which at least one of the observation image and the overhead view image is displayed on the liquid crystal panel 1 (for example, in a state shown in FIG. 4).

FIG. 6 is a flowchart showing a viewing zone adjustment method according to an embodiment. As shown in FIG. 6, first, an observation image in which one or a plurality of viewers are observed is obtained by the camera 3 (step S11).

Next, the viewer detector 13 detects the positions of the one or the plurality of viewers by using the observation image obtained in step S11 (step S12).

Next, the presentation unit 17 supplies at least one of the observation image and the overhead view image to the liquid crystal panel 1 to present the image or the images to the viewers (step S13).

A viewer selects a viewer for which a viewing zone is adjusted by using the cursor button and the decision button on the remote controller while watching at least one of the observation image and the overhead view image displayed on the liquid crystal panel 1. Specifically, one or more viewers are selected from the one or the plurality of viewers by the viewer selection unit 16 according to the input viewer selection signal (step S14).

Thereafter, for example, when a viewer presses a predetermined button on the remote controller, viewing zones are adjusted to the selected viewers. Specifically, the calculation unit 14 calculates the control parameter so that viewing zones are set in areas according to the positions of the selected viewers (step S15).

If the control parameter can be calculated in step S15 (step S16: Yes), the process proceeds to step S18.

If the control parameter cannot be calculated in step S15 (step S16: No), the calculation unit 14 calculates the control parameter so that a viewing zone is set in an area according to the position of the selected viewer to which the highest priority is given (step S17). As described above, the case in which the control parameter cannot be calculated includes for example, a case in which a plurality of viewers are selected.

The viewing zone information is also updated in steps S15 and S17, so that the viewing zones in the overhead view image are also updated.

Next, the image adjuster 15 controls viewing zones according to the control parameter calculated in steps S15 or S17 (step S18).

Then, the liquid crystal panel 1 displays parallax images (step S19).

When the three-dimensional viewing position check function is started, for example, if a predetermined button on the remote controller is pressed, a still image for checking the position may be displayed. The still image for checking the position includes a plurality of parallax images. Therefore, a viewer can check whether or not the still image is seen stereoscopically.

In this way, a selected viewer can see stereoscopically the plurality of parallax images displayed on the liquid crystal panel 1.

The video processing apparatus 100 may has an auto-tracking mode in which the viewing zones are periodically adjusted so that the viewing zones follow the selected viewers. When the auto-tracking mode is enabled, in the three-dimensional viewing position check function, a series of processes from step S11 to step S19 are periodically repeated. Therefore, in this case, the viewer detector 13 periodically detects the positions of one or a plurality of viewers (step S12). Further, the calculation unit 14 calculates the control parameter every time the positions of one or a plurality of viewers are detected (steps S15 and S17). Thereby, even when the selected viewers move, the viewing zones follow the positions of the viewers. Therefore, even if the selected viewers move after the three-dimensional viewing position check function is ended, the viewers can see the plurality of parallax images stereoscopically. After the three-dimensional viewing position check function is ended, a series of processes of steps S11, S12, and S15 to S19 (without steps S13 and S14) are periodically repeated and the viewing zones are adjusted.

### [Priority Allocation Rule]

Next, specific examples (a) to (h) of the priority allocation rule will be enumerated.

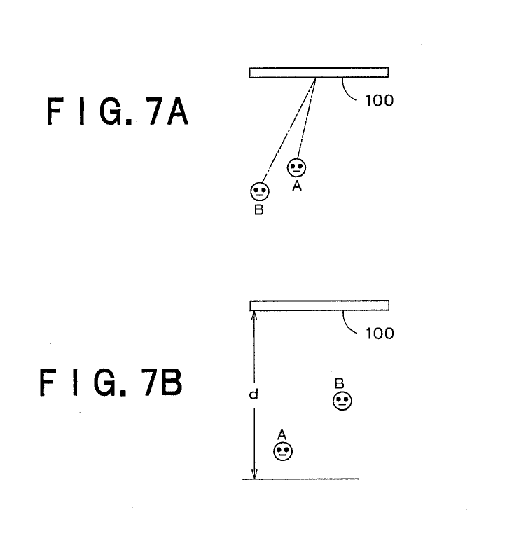

(a) A viewer located at the front of the liquid crystal panel 1 has higher probability to want to view the stereoscopic video than a viewer located at the edge of the liquid crystal panel 1. Therefore, in the priority allocation rule, as shown in FIG. 7A, the viewer A located in front of the liquid crystal panel 1 is given a priority higher than that of the viewer B located at the edge of the liquid crystal panel 1.

When the priority allocation rule is employed, for example, the viewer selection unit 16 obtains angles between the surface of the liquid crystal panel 1 and perpendicular planes passing through each viewer and the center of the liquid crystal panel 1 (max. 90°) by using the position information of the viewers, and the larger the angle, the higher the priority is given to the viewer by the viewer selection unit 16.

(b) A viewer near to an optimal viewing distance (a distance between the liquid crystal panel 1 and a viewer) to see the stereoscopic video is prioritized. In this priority allocation rule, as shown in FIG. 7B, the viewer A is given the highest priority, and the nearer the viewer to the optimal viewing distance (optimal viewing distance d) to see the stereoscopic video, the higher the priority is given to the viewer. The value of the optimal viewing distance d depends on various parameters such as the size of the liquid crystal panel, so that a different value is set for each product of video processing apparatuses. The value of the optimal viewing distance d may be set by a viewer.

When the priority allocation rule is employed, the viewer selection unit 16 obtains differences between the positions on the Z axis included in the position information of the viewers and the optimal viewing distance d, and the smaller the difference, the higher the priority is given to the viewer by the viewer selection unit 16.

(c) The longer the viewer watches a TV program, the more the viewer seems to want to watch the TV program. Therefore, in the priority allocation rule, the longer the viewer watches a TV program, the higher the priority is given to the viewer. The watching time is calculated based on, for example, the start time of the TV program being watched. The start time of the TV program being watched can be obtained from an electronic program guide (EPG) or the like. The watching time may be calculated based on the time when the program being watched is selected. The watching time may be calculated based on the time when the video processing apparatus 100 is turned on and image display is started.

When the priority allocation rule is employed, the viewer selection unit 16 calculates the watching time for each viewer, and the longer the watching time of the viewer, the higher the priority is given to the viewer by the viewer selection unit 16.

(d) The viewer who has the remote controller is most probably a main viewer because the viewer operates the remote controller to select a channel to be viewed. Therefore, in the priority allocation rule, the highest priority is given to the viewer who has the remote controller or the viewer who is nearest to the remote controller.

When the priority allocation rule is employed, the viewer detector 13 recognizes the viewer who has the remote controller and supplies the viewer recognition information of the viewer to the viewer selection unit 16. Examples of the method for recognizing the viewer who has the remote controller include a method for detecting infrared rays emitted from the remote controller or detecting a mark provided on the remote controller in advance by the camera 3 and recognizing the viewer nearest to the remote controller and a method for directly recognizing the viewer who has the remote controller by image recognition. The viewer selection unit 16 gives the highest priority to the viewer who has the remote controller. Regarding viewers other than the viewer who has the remote controller, the nearer to the remote controller the viewer is, the higher the priority the viewer may be given by the viewer selection unit 16.

(e) It is possible to store information related to users of the video processing apparatus 100 in the storage unit 18 as the user registration information. The user registration information can include information such as face photos and 3D viewing priorities that indicate the priorities to view stereoscopic video. In the priority allocation rule, a viewer who has high 3D viewing priority is prioritized.

When the priority allocation rule is employed, the viewer detector 13 obtains face information of each viewer from the image captured by the camera 3. Then, the viewer detector 13 searches for face photos in the user registration information that match the face information for each viewer, so that the viewer detector 13 reads 3D viewing priorities of the viewers from the storage unit 18. Then, the viewer detector 13 supplies a combination of the viewer recognition information (position information) and the 3D viewing priority to the viewer selection unit 16 for each viewer. The viewer selection unit 16 gives priority to viewers in order of the 3D viewing priority. Viewers with no user registration information may be given a low priority (or the lowest priority).

(f) It is assumed that viewers often see the liquid crystal panel 1 from an oblique direction instead of from the front of the liquid crystal panel 1 depending on an arrangement of the video processing apparatus 100 and furniture such as a sofa and chairs. In such a case, the viewing zones are often set in an oblique direction from the liquid crystal panel 1. Therefore, in the priority allocation rule, viewers located in positions that are often set as the viewing zones are given high priority.

When the priority allocation rule is employed, for example, every time the calculation unit 14 calculates the control parameter, the calculation unit 14 stores the calculated control parameter in the storage unit 18. The viewer selection unit 16 detects viewing zones that are set many times from the control parameter stored in the storage unit 18 and gives viewers in the viewing zones higher priority than that given to viewers located outside the viewing zones.

(g) A user of the video processing apparatus 100 can set a position at which the user can most easily view the image as an initial viewing position. In the priority allocation rule, a user sets the initial viewing position in advance and the viewer who is nearest to the initial viewing position is given priority.

When the priority allocation rule is employed, the storage unit 18 stores information related to the initial viewing position set by the user. The viewer selection unit 16 reads the set initial viewing position from the storage unit 18 and gives the highest priority to the viewer nearest to the initial viewing position.

As described above, according to the embodiment, at least one of the observation image and the overhead view image captured by the camera 3 is displayed on the liquid crystal panel 1 and one or more viewers are selected from the viewers on the observation image or the overhead view image according to the viewer selection signal input by a viewer. Then, the viewing zones from which a plurality of parallax images can be seen stereoscopically are set in areas according to the position of the selected viewer. Thereby, when there are a plurality of viewers, a viewer can freely select viewers for which the viewing zones are adjusted. Further, one viewer can adjust the viewing zones to any viewers including the viewers other than himself or herself by operating the remote controller, so that it is possible to save the trouble for a plurality of viewers to operate the remote controller by passing the remote controller to each other.

Furthermore, priorities are given to the selected viewers. Therefore, even when a part of a plurality of the selected viewers cannot be accommodated in the viewing zones, viewers with high priorities can be surely accommodated in the viewing zones, so that the viewers with high priorities can see a high quality stereoscopic video.

In this way, according to the embodiment described above, viewers can easily observe a good stereoscopic video.

### Modified Example

Various modifications can be added to the embodiment described above. Hereinafter, an example of the modified examples will be described with reference to the drawing.

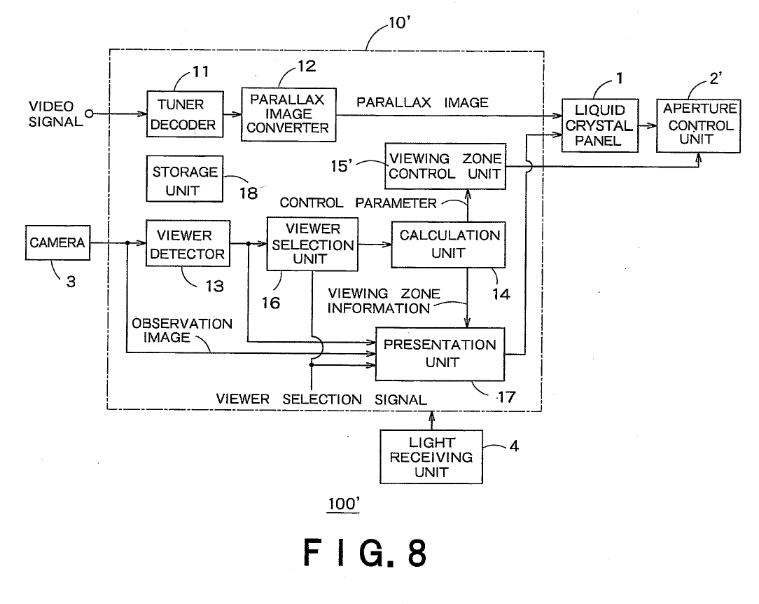

Although, in the embodiment described above, an example is described in which the viewing zones are controlled by using the lenticular lens 2 and shifting the parallax images, the viewing zones may be controlled by other methods. For example, instead of the lenticular lens 2, a parallax barrier may be provided as an aperture control unit. FIG. 8 is a block diagram showing a schematic configuration of a video processing apparatus 100′, which is a modified example of FIG. 2. As shown in FIG. 8, the controller 10′ of the video processing apparatus 100′ has a viewing zone control unit 15′ instead of the image adjuster 15. The viewing zone control unit 15′ controls the aperture control unit 2′ according to the control parameter calculated by the calculation unit 14. In this case, the distance between the liquid crystal panel 1 and the aperture control unit 2′, a horizontal shift length between the liquid crystal panel 1 and the aperture control unit 2′, or the like is regarded as a control parameter, and an output direction of a parallax image displayed on the liquid crystal panel 1 is controlled, thereby controlling the viewing zones. In this way, the viewing zone control unit 15′ may control the aperture control unit 2′ without performing processing for adjusting the display position of the parallax images displayed on the liquid crystal panel 1.

Further, although the observation image and the overhead view image are displayed on the liquid crystal panel 1 in the embodiment described above, it is not limited to this. For example, the presentation unit 17 may transmit at least one of the observation image and the overhead view image to an information terminal, a personal computer, or the like connected to the video processing apparatus 100 via wired or wireless communication. In this case, a viewer can select viewers by seeing at least one of the observation image and the overhead view image displayed on the information terminal and operating the information terminal. The information terminal can transmit the viewer selection signal to the operation signal receiving unit of the video processing apparatus 100. Further, a liquid crystal display device or the like is provided on the remote controller and the presentation unit 17 transmits at least one of the observation image and the overhead view image to the remote controller, so that the presentation unit 17 may cause the liquid crystal display device to display and present at least one of the images to a viewer.

The same effects as those of the above-described embodiment can be obtained by these modified examples.

At least a part of the controller 10 described in the above embodiment may be made up of hardware or software. When forming at least a part of the controller 10 by software, a program that realizes a part of the functions of the controller 10 is stored in a recording medium such as a flexible disk and a CD-ROM, and the program is read and executed by a computer. The recording medium is not limited to an attachable and detachable medium such as a magnetic disk and an optical disk, but may be a fixed recording medium such as a hard disk device and a memory.

A program that realizes at least a part of the functions of the controller 10 may be distributed via a communication line such as the Internet (including wireless communication). Further, the program, which is encrypted, modulated, and/or compressed, may be distributed via a wired line or a wireless line or by storing the program in a recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A video processing apparatus comprising:
a display configured to display a plurality of parallax images;
an aperture control unit configured to output the plurality of parallax images displayed on the display unit in a direction;
an observation unit configured to obtain an observation image comprising one or more viewers;
a viewer detector configured to detect positions of the one or more viewers in the observation image;
a presentation unit configured to present the observation image to the one or more viewers;
a viewer selection unit configured to select one or more viewers in the observation image according to a viewer selection signal;
a calculator configured to calculate a control parameter so that a viewing zone, from which the plurality of parallax images can be seen stereoscopically, is set in areas according to positions of the selected one or more viewers; and
a controller configured to control the viewing zone according to the control parameter.

2. The video processing apparatus according to claim 1, wherein:
the presentation unit is configured to supply the observation image to the display, and
the display is configured to display the observation image.

3. The video processing apparatus according to claim 2, wherein:
the presentation unit is configured to generate an overhead view image showing a positional relationship among the display, the viewing zone, and the one or more viewers by using position information of the one or more viewers and viewing zone information showing the viewing zone, the presentation unit further configured to supply the overhead view image to the display, and
wherein the display unit is configured to display the observation image and the overhead view image.

4. The video processing apparatus according to claim 1, further comprising:
an operation signal receiving unit configured to receive the viewer selection signal,
wherein the viewer selection signal is configured to be transmitted from a remote controller.

5. The video processing apparatus according to claim 1, wherein:
when a plurality of viewers are selected, the calculation unit is configured to calculate the control parameter so that the viewing zone is set in areas according to positions of all the selected viewers.

6. The video processing apparatus according to claim 5, wherein:
the viewer selection unit is configured to give priorities to the selected viewers according to a priority allocation rule, and
when the calculation unit cannot calculate the control parameter so that the viewing zone is set in areas according to the positions of all the selected viewers, the calculation unit is configured to calculate the control parameter so that the viewing zone is set in an area according to a position of the selected viewer to which a highest priority is given.

7. The video processing apparatus according to claim 5, wherein:
the viewer selection unit is configured to select one or more viewers by giving a priority to each viewer according to the viewer selection signal, and
when the calculation unit cannot calculate the control parameter so that the viewing zone is set in areas according to the positions of all the selected viewers, the calculation unit is configured to calculate the control parameter so that the viewing zone is set in an area according to a position of the selected viewer to which a highest priority is given.

8. The video processing apparatus according to claim 1, wherein:
the viewer selection unit is configured to give priorities to the selected viewers according to a priority allocation rule, and
the calculation unit is configured to calculate the control parameter so that the viewing zone is set in an area according to a position of the selected viewer to which a highest priority is given.

9. The video processing apparatus according to claim 1, wherein:
the viewer selection unit is configured to select the selected one or more viewers by giving a priority to each viewer according to the viewer selection signal, and
the calculation unit is configured to calculate the control parameter so that the viewing zone is set in an area according to a position of the selected viewer to which a highest priority is given.

10. The video processing apparatus according to claim 6, wherein:
the viewer selection unit is configured to give higher priorities to a viewer nearer an optimal viewing distance for viewing the plurality of parallax images stereoscopically.

11. The video processing apparatus according to claim 6, wherein:
the viewer selection unit is configured to give higher priorities to a viewer the longer the viewer watches a program.

12. The video processing apparatus according to claim 1, wherein:
the viewer detector is configured to periodically detect the positions of the one or more viewers, and
the calculation unit is configured to calculate the control parameter every time the positions of the one or more viewers are detected.

13. A video processing apparatus comprising:
a display configured to display a plurality of parallax images;
an aperture control unit configured to output the plurality of parallax images displayed on the display in a direction;
an observation unit configured to obtain an observation image comprising one or more viewers;
a viewer detector configured to detect positions of the one or more viewers in the observation image;
a presentation unit configured to generate an overhead view image showing a positional relationship among the display, a viewing zone, and the one or more viewers by using position information of the one or more viewers and viewing zone information showing the viewing zone, and configured to present the overhead view image to the one or more viewers, wherein the plurality of parallax images displayed on the display unit can be seen stereoscopically from the viewing zone;
a viewer selection unit configured to select a selected one or more viewers from the one or more viewers on the overhead view image according to a viewer selection signal;
a calculator configured to calculate a control parameter so that the viewing zone is set in areas according to positions of the selected viewers; and
a viewing zone control unit configured to control the viewing zone according to the control parameter.

14. A video processing method comprising:
obtaining an image of one or more viewers;
detecting positions of the one or more viewers in the image;
presenting the image to the one or more viewers;
selecting one or more viewers in the image according to a viewer selection signal;
calculating a control parameter so that a viewing zone, from which a plurality of parallax images displayed on a display can be seen stereoscopically, is set in areas according to positions of the selected viewers; and
controlling the viewing zone according to the control parameter.
